(19) United States
(12) Patent Application Publication
(10) Pub. No.: US 2008/0275832 A1
(43) Pub. Date: Nov. 6, 2008

(54) Electronic Synapse Device

(76) Inventors: Liam McDaid, County Donegal (IE); Peter Kelly, County Londonderry (GB)

Correspondence Address: NATH & ASSOCIATES, 112 South West Street, Alexandria, VA, 22314, US

(21) Appl. No.: 11/887,269

(22) PCT Filed: Mar. 29, 2006
(86) PCT No.: PCT/EP2006/003085

§ 371 Date: Jun. 25, 2008

(30) Foreign Application Priority Data
Mar. 29, 2005 (GB) 0506253.4

(51) Int. Cl. G06N 3/02

(52) U.S. Cl. 706/33

(57) ABSTRACT

An electronic synapse device comprising a substrate formed from semiconductor material; a first input for receiving a weighting signal; a second input for receiving a signal from a pre-synaptic neuron device; an insulating layer provided between the first and second inputs and the semiconductor material; and an output, the second input being located between the first input and the output. Upon application of the weighting signal to the first input a quantity of charge accumulates in said substrate in the region said first input. Subsequently, upon application of the pre-synaptic signal to the second input, the charge is transferred to a region of the substrate that is substantially in register with the second input whereupon the charge causes an output signal to be generated at the output.

### FIELD OF THE INVENTION

The present invention relates to an electronic synapse device.

### BACKGROUND TO THE INVENTION

Biologically-inspired computing machines based on neural networks offer solutions to mathematically intractable problems through their ability to be trained for specific tasks. A typical feed-forward neural network is shown in FIG. 1a, generally indicated as 10. The network 10 comprises a plurality of neurons 12, each neuron 12 in one layer, e.g. the input layer (on the left hand side of FIG. 1a), is connected to every neuron 12 in the next layer via a synapse 14 and so on: the network 10 could have many layers. For clarity only a few synapses 14 are shown in FIG. 1a. FIG. 1b shows one neuron 12 of the network 10 to highlight that for every neuron 12 there may be many synapses 14. Each synapse 14 forms a connecting node in a pathway between neurons 12, as shown in FIG. 1a.

The realisation of neural networks in software is by far the most common manifestation of this computational technique. However, many applications exist where neural computations running on software platforms may not be an option, for example biological implants, and a hardware implementation is the preferred option, particularly as this route to implementation preserves the parallel processing capability of a biological neural system. If very large scale, highly parallel, hardware implementations of artificial neurons are to become a reality it is essential that neurons with small physical dimensions are made available to facilitate this. Considering that each neuron in a biological system is associated with many synapses, it follows that in hardware implementations of biologically plausible neurons the physical space occupied by synapses will far exceed that occupied by the summing/thresholding point neuron.

A problem to be solved is that a hardware synapse not only needs to have the correct biological function, but it must also be physically small and consume minimal power.

Current techniques for emulating a synapse in either digital or analogue hardware is mostly circuit based, which is area consuming. There have also been attempts to restrict the area of hardware synapses by moving away from circuits to single components, namely transistors that are forced to act as synapses. However, current VLSI architectures based on transistor based synapses still fail to match the scale of biological networks because the fundamental building blocks (transistors) do not possess the correct physical attributes to emulate a synapse. The solid-state characteristics of single-transistor based synapses are simply too restrictive in the way they attempt to mimic synaptic plasticity.

It would be desirable, therefore, to provide a small and efficient hardware implementation of a synapse.

### SUMMARY OF THE INVENTION

Accordingly, a first aspect of the invention provides an electronic synapse device comprising: a substrate formed from semiconductor material; a first input for receiving a weighting signal; a second input for receiving a signal from a pre-synaptic neuron device; an insulating layer provided between said first and second inputs and said semiconductor material; and an output, the second input being located between said first input and said output.

During operation of the preferred device, upon application of said weighting signal to said first input, a quantity of charge accumulates in said substrate in the region of said first input, and, upon application of said pre-synaptic signal to said second input, said charge is transferred to a region of said substrate that is substantially in register with said second input whereupon said charge causes an output signal to be generated at said output.

Conveniently, the output comprises a charge collector. The charge collector may comprise a region of said substrate doped to create a p-n or n-p junction in said substrate adjacent a region of said substrate that is substantially in register with said second input. The p-n or n-p junction is biased to attract charge which accumulates in said substrate as a result of application of said weighting signal to said first input. In a typical embodiment, where the substrate comprises p-type semiconductor material and said doped region comprises N+ type semiconductor material, the resulting p-n junction is reverse biased in use. Biasing of the junction may be achieved by applying suitable voltage levels to the output of the device and to one or both of the input terminals, e.g. the first input terminal.

In the preferred embodiment, the first and second inputs are located adjacent one another on one side of said insulating layer. The first input advantageously comprises a floating gate.

The weighting signal applied, during use, to said first input is typically at a fixed level during each operational cycle of the synapse device. This causes a fixed or finite quantity of charge to accumulate in the region of the first input, which is then transferred to the region of the second input and ultimately to the output upon receipt of the pre-synaptic signal at the second input. It is preferred, however, that the level of said weighting signal is adjustable between operational cycles. This allows different quantities of charge to be accumulated and so the output of the device is adjusted accordingly. The signal applied, during use, to said second input conveniently comprises a clocking signal, for example, a spike signal, a pulse signal or a step signal.

In the preferred embodiment, the first and second inputs, the insulating layer and the substrate together form a first capacitor structure and a second capacitor structure located side-by-side. The capacitor structures preferably each comprise a respective MOS capacitor.

A second aspect of the invention provides an electronic neural structure comprising a pre-synaptic neuron device and a post-synaptic neuron device in communication with one another by means of an electronic synapse device of the first aspect of the invention.

In a typical embodiment, the pre-synaptic neuron device provides, in use, a pre-synaptic signal to said second input of the synapse device, and said synapse device provides a corresponding weighted output signal to said post-synaptic neuron device via the output of the synapse device, said neural structure further including, means for applying said weighting signal to said first input.

A third aspect of the invention provides an electronic neural network comprising at least one electronic neural structure according to the second aspect of the invention.

A fourth aspect of the invention provides a method of emulating the operation of a synapse using an electronic synapse device according to the first aspect of the invention, the method comprising causing a quantity of charge to accumulate in said substrate in the region of said first input by application of a weighting signal to said first input; and causing said charge to be transferred to said output by application of an input signal to said second input.

In preferred embodiments, the device includes, or is associated with, means for applying a biasing signal to said first input such that a quantity of charge is created in said substrate in register with, or in the region of, said first input, and wherein, upon application of an input signal to said second input, said charge is transferred to said output to create an output signal.

The biasing signal applied to the first input serves as the weighting signal which determines the amount of charge that is created and so determines the weight that the electronic synapse applies to a received signal from a pre-synaptic neuron structure. The second input receives, during use, signals from a pre-synaptic neuron. Advantageously, signals received at the second input need only be in the form of a spike, pulse or step in order to effect charge transfer.

The output signal, which during use may be supplied to a post synaptic neuron structure, typically takes the form of a transient or spike signal and as such is comparable in shape to output signals from biological synapses. The magnitude of the output signal is determined by the amount of charge that is created and is thus dependent on the level of the weighting signal to the first input.

In the preferred embodiment, said charge accumulates in an inversion layer adjacent the interface of the substrate and the insulating layer, in register with, or in the region of, the first input.

Further advantageous aspects of the invention will become apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1a shows a representation of a feed forward neural network;

FIG. 1b shows an enlarged view of part of the network of FIG. 1a;

FIG. 2 shows a representation of a neuron to neuron structure with synaptic junction; and

FIG. 3 shows a schematic view of a preferred electronic synapse device embodying the invention.

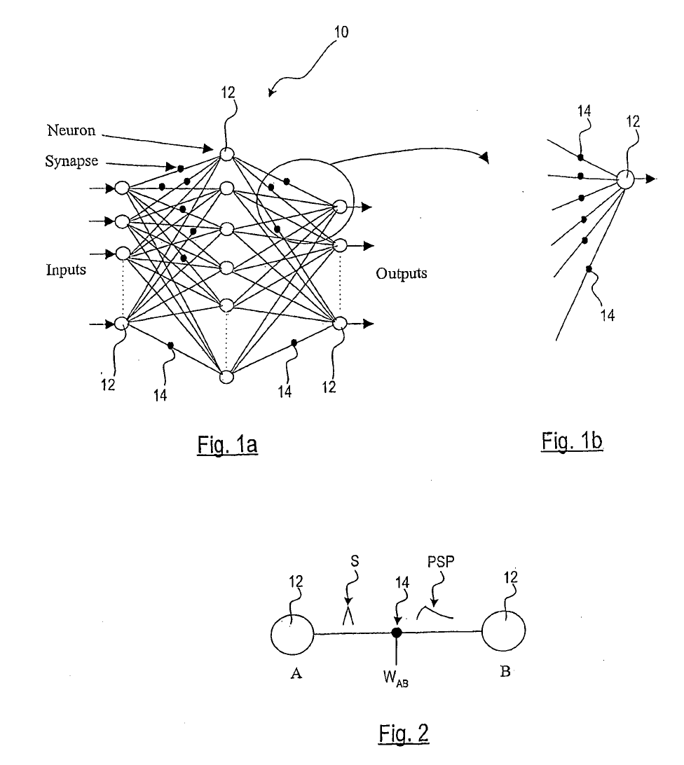

### DETAILED DESCRIPTION OF THE DRAWINGS

With reference to FIG. 2, an artificial model for a biological synapse is now described. It is noted that biological synapses are known to exhibit extremely complex statistical behaviour and usually only first order models are considered. FIG. 2 shows a fragment of a neural network consisting of two point neurons (A and B) with an intermediate synapse or synaptic junction 14.

Neuron A outputs a spike S, which forms the input to the synaptic junction 14. At the junction 14 the spike S is transmitted to the output neuron B, its magnitude having been weighted according to a weight value W_{AB}. The output of the synapse, known as the Post Synaptic Potential (PSP), resembles a transient function where the rise time constant and fall time constant are significantly different from each other. This behaviour is caused by the loading effect associated with the post-synaptic membrane time constant. Therefore, it is accurate to assume that in the absence of this loading effect, the output of a synapse is essentially another spike whose magnitude is modulated by a weight W_{AB} provided at a weight input (i.e. it behaves essentially as an analogue multiplier).

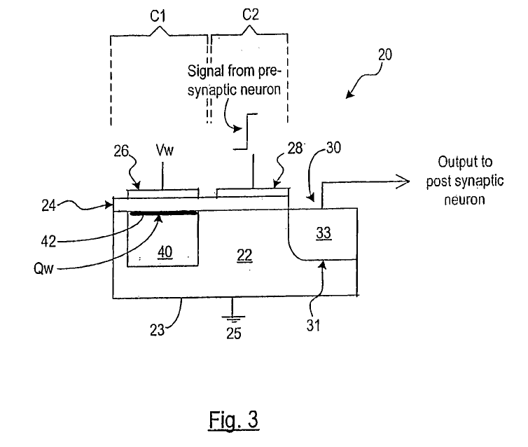

FIG. 3 presents a schematic view of an electronic synapse device, generally indicated as 20, embodying the invention in a preferred form. The device 20 comprises a substrate 22 of semiconductor material which, in the illustrated embodiment, comprises p-type semiconductor material. Any conventional semiconductor material, for example silicon, may be used. An electrically insulating layer 24 is provided adjacent, or on, the substrate 22, typically in the form of an oxide layer, e.g. a silicon dioxide layer. A first input terminal or electrode 26, typically formed from metal, for example aluminum, is provided adjacent, or on, the insulator layer 24 such that the insulator layer 24 is located between the electrode 26 and the substrate 22. The first electrode 26 serves as a first input gate and, in preferred embodiments, comprises a floating gate. A second input terminal or electrode 28, typically formed from metal, for example aluminum, is provided adjacent, or on, the insulator layer 24 such that the insulator layer 24 is located between the electrode 28 and the substrate 22. The second electrode 28 serves as a second input gate. Conveniently, the first and second electrodes 26, 28 are located adjacent one another.

The substrate 22 is tied to a reference potential, typically electrical ground (shown as element 25 in FIG. 3), distal the insulator layer 24. Normally, a contact layer (not shown) is provided at the surface 23 of the substrate 22 for making a connection to ground, or other reference potential.

The device 20 includes an output including an output terminal 30. In the preferred embodiment, the output comprises a charge collector which may be formed by an appropriately, in this case reverse, biased p-n junction 31. In the present example, this is achieved by doping the substrate 22 in the region of the output 30 to create an N+ region 33. Hence, any electrons arriving at the junction 31 are collected and output at terminal 30. In the present example, the collector is an electron collector and so collects electrons from the substrate 22. In alternative embodiments (not illustrated) where the substrate is an n-type substrate and region 33 is doped such that junction 31 is an n-p junction, the collector is a hole collector, i.e. a collector of positive charge. As well as providing an output signal, the terminal 30 may be used to apply an appropriate biasing voltage for the junction 31.

The device 20 shown in FIG. 3 is similar in structure to a first and a second MOS (Metal Oxide Semiconductor) capacitor (identified generally as C1 and C2 in FIG. 3) located adjacent one another. In the preferred embodiment, therefore, the device 20 may be said to comprise two MOS capacitors side-by-side, for example in a manner similar that exhibited by a CCD (charge coupled device) structure. The first input or gate 26 serves as an input for the first capacitor C1, the second input or gate 28 serving as an input for the second capacitor C2. The first and second capacitors C1, C2 share a common substrate 22, insulator layer 24 and reference terminal (in this case electrical ground).

As will be seen from the following description, the first MOS capacitor C1 stores, during use, a quantity of electrical charge in the substrate 22 at the junction with the insulator layer 24 and in register with, or in the region of the first gate electrode 26 when the substrate 22 is appropriately biased which, in the preferred embodiment, depends on the level of voltage applied to the first gate electrode 26. By applying a voltage, for example a spike, pulse or step voltage, to the second gate electrode 28, i.e. to the second MOS capacitor C2, the stored charge is released as is described in more detail below. It will be understood that a capacitor in this context comprises a semiconductor material which is electrically isolated from the gate electrode by an electrically insulating material, i.e. insulator layer 24, the gate electrode and insulating material being provided at one side of the semiconductor material, another, e.g. the opposite, side of the semiconductor material being provided with a terminal or contact for connection to a reference potential.

During use, a voltage Vw is applied to the first gate 26 in order to bias the substrate 22 such that a depletion layer 40 is formed in the substrate 22 in register with, or in the region of (beneath as viewed in FIG. 3), the first gate 26 and such that an inversion layer 42 is created in substrate 22 in register with, or in the region of, the first gate 26 at the semiconductor-insulator interface. In this embodiment, the inversion layer 42 comprises a quantity of charge Qw in the form of electrons (negative charge), the amount of which depends on the level of the voltage applied to the first gate 26. In an alternative embodiment where the substrate comprises n-type semiconductor material the charge may be comprised of holes, i.e. positive charge. The voltage Vw, which in the present example comprises a positive voltage with respect to ground, may be referred to as a weight voltage. In comparison with the synapse model of FIG. 2, the gate input 26 of the device 20 serves as the weight input for the synapse, the applied voltage Vw corresponding to the weight W_{AB}. The voltage Vw may be applied by any suitable means and may be fixed or variable. In the preferred embodiment, the device 20 includes, or is associated with, means for biasing the device 20 via the first gate 26 in order to create the desired charge Qw. The biasing means preferably takes the form of means for applying a voltage to the first gate 26. By way of example, a memory device (not shown), or a programmable memory device, may be used to provide the voltage Vw. The level of voltage applied to gate 26 may be varied depending on the required operation of the device 20 (i.e. depending on the required weight W_{AB}), although normally the voltage applied to the first gate 26 is fixed during use so that a known, finite quantity of charge builds up in the inversion layer 42.

The second gate 28 serves as an input for receiving a pre-synaptic signal, i.e. a signal from a device (not shown) acting as a pre-synaptic neuron (for example neuron A in FIG. 2). The pre-synaptic signal is such that, in a quiescent state, the charge Qw remains in the inversion layer 42. However, when the pre-synaptic signal adopts an active state, it biases the substrate 22 such that a region in register with, or in the region of (beneath as viewed in FIG. 3), the second gate 28 is driven into depletion. Typically, the pre-synaptic signal takes the form of a pulse or spike. In the present embodiment, the active state of the pre-synaptic signal involves the application of a voltage, in this example a positive voltage, to the second gate 28 in order cause depletion in the substrate 22 at the second gate 28.

During use, when the pre-synaptic signal is in its quiescent state, a finite quantity of charge Qw is stored at the semiconductor-insulator interface (i.e. in the inversion layer 42) of capacitor C1 as a result of the weight voltage Vw.

When a pulse, or other pre-synaptic signal, is transmitted to the second gate 28 by a pre-synaptic neuron device, the silicon, or other semiconductor material, beneath, or in the region of, the gate 28 of capacitor C2 is driven into deep depletion. This causes the charge Qw to drift laterally from the first capacitor C1 to the second capacitor C2, and in particular to the depleted region beneath the second gate 28, and subsequently to the output terminal 30 whereupon the charge Qw gives rise to an output signal from the output terminal 30. The output signal serves as a post synaptic signal for a post synaptic neuron device (e.g. neuron B in FIG. 2). Since Qw is established through thermal generation of electron/hole pairs in the depletion layer 40 beneath the gate 26 of capacitor C1, the lateral drift of charge Qw results in a transient current at the output terminal 30, as the density of charge in the inversion layer 42 diminishes with time. Hence, the post synaptic output signal to the post synaptic neuron will be a transient (e.g. a spike is generated) whose magnitude is affected by the density of charge Qw that builds in the inversion layer 42 as a result of the magnitude of voltage Vw. Therefore, synaptic plasticity is achieved.

The physical size of the device 20 can be minimised since the magnitude of the output signal, or spike, relative to other spikes is of main interest.

It is noted that, in the preferred embodiment, there is no requirement on the pre-synaptic neuron device to generate a spike to “clock” the gate 28 of capacitor C2. A simple step voltage is suitable as the pre-synaptic input to gate 28 since the only requirement is to transfer the packet of charge Qw in the inversion layer 42 to the post-synaptic neuron device in the form of a post synaptic signal. Because the inversion layer 42 does not comprise an infinite supply of charge (in contrast to the source of a conventional MOSFET transistor) the output signal from the capacitor C2 exhibits a transient or spike characteristic followed by leakage arising from background thermally generated currents. Although this latter current component serves to replace the inversion after the clock pulse, its magnitude will be insignificant compared to that of the spike. Therefore, as the pre-synaptic neuron device is only required to generate a voltage step instead of a spike, the design of the pre-synaptic neuron device is also greatly simplified.

Also, a refractory period exists in real neurons where a finite time, of the order of milliseconds, is required between spikes for the neuron to re-establish its equilibrium membrane potential. In a preferred embodiment, the device 20 may mimic the refractory period because the time duration to establish an inversion layer, after a spike event, by thermal generation of electron/hole pairs may be arranged to be in the order of milliseconds for a suitably engineered semiconductor material. In addition, there are a number of possible approaches to storing weight voltages, including non-volatile memory-like structures, for example with dual gate operation which would integrate well with the device 20.

It will be understood from the foregoing that the charge packet Qw, which contains a finite amount of charge determined by the voltage Vw on the first electrode 26, results in a transient “spike” signal or current at the output 30 of the second capacitor C2, provided the second capacitor C2 is sufficiently close to the first capacitor C1 to cause the charge Qw to drift, as described above, upon application of a pre-synaptic signal to the gate 28 of the second capacitor C2. The ability to store a finite amount of charge Qw and release it in the manner described provides a very simple and efficient method of current spike generation and therefore of a suitable post synaptic signal. By adjusting the voltage Via, different levels of charge Qw can be stored and hence synaptic plasticity is achieved.

The device 20 provides a realistic electronic synapse capable of mimicking the behaviour of a biological synapse whilst remaining compact since it is device based and not circuit based. Moreover, since only a transient current flows during charge transfer, the device consumes relatively little power.

Effectively, the device 20 acts as a multiplier, which is currently the accepted model of a synapse. However, the device 20 can be fabricated in sub-micron dimensions and, unlike conventional analogue multipliers, no standby current flows.

It will be understood that the invention is not limited to use with a p-type substrate. For example, the substrate 22 may be formed from n-type material, in which case region 33 would be doped to be a P+ type region and the biasing of the device would be the reverse of the device 20, as would be apparent to a skilled person.

It will be apparent from the foregoing that, in the preferred embodiment, the synapse device comprises a charge transfer structure or CCD structure having charge storage capacity, typically a floating gate charge transfer structure or CCD structure, the structure comprising two MOS capacitors side-by-side and in close proximity with one another, and an output. The charge storage is achieved using the floating gate region of the first MOS capacitor whereby the stored charge induces an inversion layer of charge at the oxide-semiconductor interface of the substrate. The current flow between the two capacitors is a transient and so power consumption is negligible.

A weight voltage is applied to the input gate of the first capacitor which operates in strong inversion causing a linear increase of the inversion layer charge arising from the thermal generation of electron-hole pairs in the depletion region. A presynaptic signal, e.g. a step or spike, controls the gate of the second capacitor which will not be in thermal equilibrium as it operates in deep depletion state. A deeper potential well is formed under the second gate in comparison with the first, causing an abrupt potential change between two gates if they are sufficiently close together. The gathered charge Qw therefore drifts laterally from the first capacitor to the second capacitor and subsequently to the output. The charge density in the inversion layer diminishes with time and so the transfer of charge will result in a spiking current at the output. The characteristics of the spike depends on the charge concentration in the inversion layer and the time constant associated with the depletion layer of the second capacitor.

By way of example, the region 33 at the output may be doped with N_{D}=10¹⁹ cm⁻³ and the p-type substrate 22 may be doped with N_{A}=10¹⁶ cm⁻³. The respective gates 26, 28 may be spaced between 0.2 microns and 0.5 microns apart. The thickness of the oxide layer 24 may be between 0.02 microns and 100 nm. The output may comprise an electrode collector on the N+ region 33. Fixed voltages of +5V and +3V may be applied respectively to the collector electrode 30 and first gate 26. The signal applied to the second gate 28 may comprise a +5V transient voltage, ramped over a period of 1 ns and then applied to gate 28 with a time step of 10⁻⁶ ns. It will apparent to a skilled person that these dimensions, voltages and other characteristics may be varied while still achieving the functionality described herein.

Synapse devices embodying the invention may readily be associated with one or more pre-synaptic and/or post synaptic neuron devices or structures to form a neuron cell. Any conventional electronic neuron device may be used to provide the functionality of the pre-synaptic and/or post synaptic neuron. For example, the, or each, post synaptic neuron structure may comprise a multi-input floating gate MOSFET, or similar device, the output signal of one or more electronic synapse device providing the input at a respective gate of the MOSFET or similar device.

The invention is not limited to the embodiment described herein and may be modified or varied without departing from the scope of the invention.

1. An electronic synapse device comprising: a substrate formed from semiconductor material; a first input for receiving a weighting signal; a second input for receiving a signal from a pre-synaptic neuron device; an insulating layer provided between said first and second inputs and said semiconductor material; and an output, the second input being located between said first input and said output.

2. A device as claimed in claim 1, wherein, upon application of said weighting signal to said first input, a quantity of charge accumulates in said substrate in the region of said first input, and wherein, upon application of said pre-synaptic signal to said second input, said charge is transferred to a region of said substrate that is substantially in register with said second input whereupon said charge causes an output signal to be generated at said output.

3. A device as claimed in claim 1, wherein said output comprises a charge collector.

4. A device as claimed in claim 3, wherein said charge collector comprises a region of said substrate doped to create a p-n or n-p junction in said substrate adjacent a region of said substrate that is substantially in register with said second input.

5. A device as claimed in claim 4, wherein said p-n or n-p junction is biased to attract charge which accumulates in said substrate as a result of application of said weighting signal to said first input.

6. A device as claimed in claim 1, wherein said first and second inputs are located adjacent one another on one side of said insulating layer.

7. A device as claimed in claim 1, wherein said first input comprises a floating gate.

8. A device as claimed in claim 1, wherein the weighting signal applied, during use, to said first input is at a fixed level during each operational cycle of the synapse device.

9. A device as claimed in claim 8, wherein the level of said weighting signal is adjustable between operational cycles.

10. A device as claimed in claim 1, wherein the signal applied, during use, to said second input comprises a clocking signal.

11. A device as claimed in claim 1, wherein the first and second inputs, the insulating layer and the substrate together form a first capacitor structure and a second capacitor structure located side-by-side.

12. A device as claimed in claim 11, wherein the capacitor structures each comprise a respective MOS capacitor.

13. An electronic neural structure comprising a pre-synaptic neuron device and a post-synaptic neuron device in communication with one another by means of an electronic synapse device as claimed in claim 1.

14. An electronic neural structure as claimed in claim 13, wherein said presynaptic neuron device provides, in use, a pre-synaptic signal to said second input of the synapse device, and said synapse device provides a corresponding weighted output signal to said post-synaptic neuron device via the output of the synapse device, and wherein said neural structure further includes, means for applying said weighting signal to said first input.

15. An electronic neural network comprising at least one electronic neural structure as claimed in claim 13.

16. A method of emulating the operation of a synapse using an electronic synapse device as claimed in claim 1, the method comprising causing a quantity of charge to accumulate in said substrate in the region of said first input by application of a weighting signal to said first input; and causing said charge to be transferred to said output by application of an input signal to said second input.
